(19) United States
(12) Patent Application Publication
(10) Pub. No.: US 2017/0251870 A1
(43) Pub. Date: Sep. 7, 2017

(54) COOKWARE ASSEMBLY WITH A SECURABLE LID FOR BAKEWARE

(71) Applicant: WKI Holding Company, Inc., Rosemont, IL (US)

(72) Inventors: Patrick Kerulis, Bartlett, IL (US); Boqiang Wang, Danjiangkou (CN)

(21) Appl. No.: 15/449,823

(22) Filed: Mar. 3, 2017

Related U.S. Application Data
(60) Provisional application No. 62/304,178, filed on Mar. 5, 2016.

(51) Int. Cl. A47J 36/10; A47J 36/04; A47J 27/00

(52) U.S. Cl. CPC A47J 36/10; A47J 27/002; A47J 36/04

(57) ABSTRACT

A storage lid and a cookware assembly are provided that includes a cover portion having a top surface, first and second sidewalls and a flexible locking tab. The first and second locking tabs each have a lateral portion and a locking portion. The lateral portion has an inner surface and an outer surface and extends outwardly from the sidewall in a direction that is generally parallel to the top surface of the cover portion. The locking portion extends downwardly and inwardly at an angle from the lateral portion. A locking protuberance is disposed on the inner surface of the locking portion, and an elongate aperture that terminates proximate the locking protuberance is disposed in a portion of the lateral portion and the locking portion.

### CROSS-REFERENCE TO RELATED APPLICATIONS

This application claims the benefit of U.S. Provisional Application No. 62/304,178, filed Mar. 5, 2016, which is incorporated herein by reference in its entirety.

### FIELD OF THE INVENTION

The present invention relates to a cookware assembly, and more particularly to a cookware assembly that includes a securable lid for a cookware vessel with tab handles.

### SUMMARY

According to the present invention, a storage lid for a vessel is provided. The storage lid includes a cover portion having a top surface, a first sidewall connected to the sidewall, a second sidewall connected to the sidewall, and flexible first and second locking tabs. The first and second sidewalls each extend downwardly and terminate at a terminal end. The first and second sidewalls also each have a first side an opposed second sides.

The flexible first locking tab is connected to the cover at a position between the first end of the first sidewall and the second end of the second sidewall. The flexible second locking tab is connected to the cover at a position between the second end of the first sidewall and the first end of the second sidewall. The first and second locking tabs each have a lateral portion and a locking portion. The lateral portion of each of the locking tabs has an inner surface and an outer surface and extends outwardly in a direction that is generally parallel to the top surface of the cover portion. The locking portion extends downwardly and inwardly at an angle from the lateral portion. The locking portion has an inner surface and an outer surface. A locking protuberance is disposed on the inner surface of the locking portion, and an elongate aperture is disposed in a portion of the lateral portion and the locking portion. The elongate aperture terminates proximate the locking protuberance.

A cookware assembly comprising a cookware vessel and a lid is also provided. The cookware includes a base and a sidewall that extends upwardly from the base and terminates in an upper rim. The cookware vessel also includes a first tab handle extending outwardly from the upper rim and a second tab handle extending outwardly from the upper rim. The second tab handle is disposed opposite the first tab handle.

The storage lid of the cookware assembly includes a cover portion having a top surface, a first sidewall connected to the sidewall, a second sidewall connected to the sidewall, and flexible first and second locking tabs. The first and second sidewalls each extend downwardly and terminate at a terminal end. The first and second sidewalls also each have a first side and opposed second sides.

The flexible first locking tab is connected to the cover at a position between the first end of the first sidewall and the second end of the second sidewall. The flexible second locking tab is connected to the cover at a position between the second end of the first sidewall and the first end of the second sidewall. The first and second locking tabs each have a lateral portion and a locking portion. The lateral portion of each of the locking tabs has an inner surface and an outer surface and extends outwardly in a direction that is generally parallel to the top surface of the cover portion. The locking portion extends downwardly and inwardly at an angle from the lateral portion. The locking portion has an inner surface and an outer surface. A locking protuberance is disposed on the inner surface of the locking portion, and an elongate aperture is disposed in a portion of the lateral portion and the locking portion. The elongate aperture terminates proximate the locking protuberance.

Other features and advantages of the invention will be apparent from the following specification taken in conjunction with the following drawings.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a cookware assembly comprising a vessel and a storage lid according to the present disclosure.

FIG. 2 is an exploded view of the cookware assembly of FIG. 1.

FIG. 3 is a cross-sectional view of the cookware assembly of FIG. 1 taken along the line 3-3.

FIG. 4 is a bottom view of the flexible locking tab of the storage lid of the present disclosure.

FIG. 5 is a top view of a lid for the cookware assembly of the present disclosure.

FIG. 6 is a bottom view of the lid of FIG. 5.

FIG. 7 is a right side view of the lid of FIG. 5.

FIG. 8 is a left side view of the lid of FIG. 5.

FIG. 9 is a right end view of the lid of FIG. 5.

FIG. 10 is a left end view of the lid of FIG. 5.

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

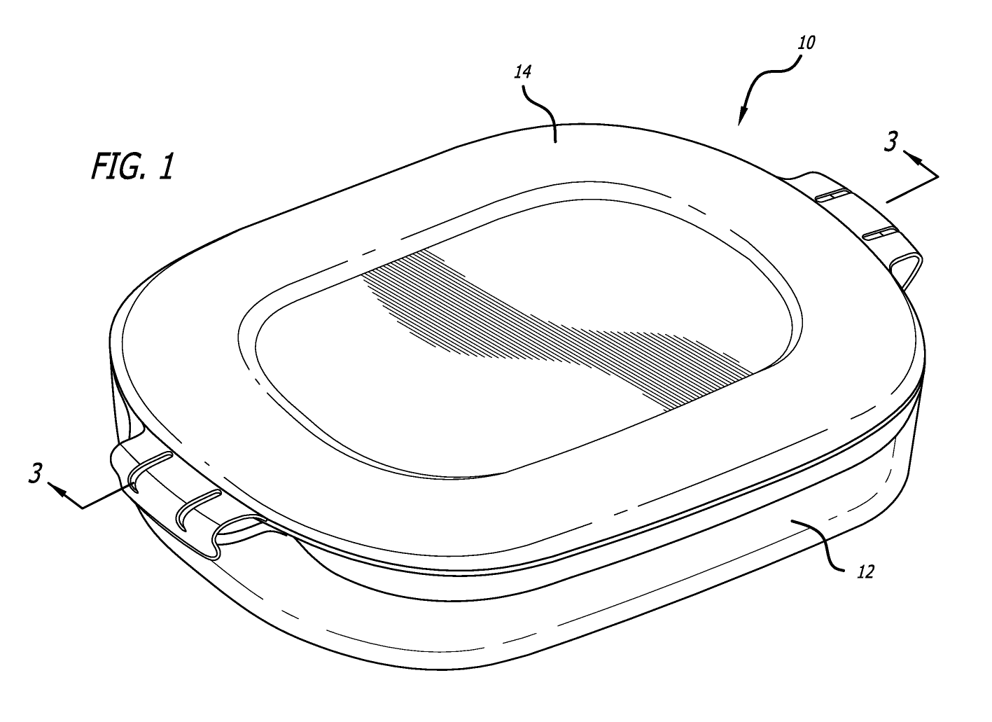

Disclosed herein are various embodiments of a cookware vessel and lid assembly 10. As shown in FIGS. 1-3, a vessel 12 and a storage lid 14 is configured to be securably attached to the vessel 12 are provided in this disclosure.

The vessel 12 is a cookware vessel of the type that may be generally suitable for ovenable, stovetop or microwaveable use. Accordingly, the vessel 12 may be formed from glass, ceramic, pyroceram or any other material suitable for oven, stovetop or microwave application. However, it will be understood that the principles of the present disclosure are suitable for any vessel 12 configured in the manner described herein.

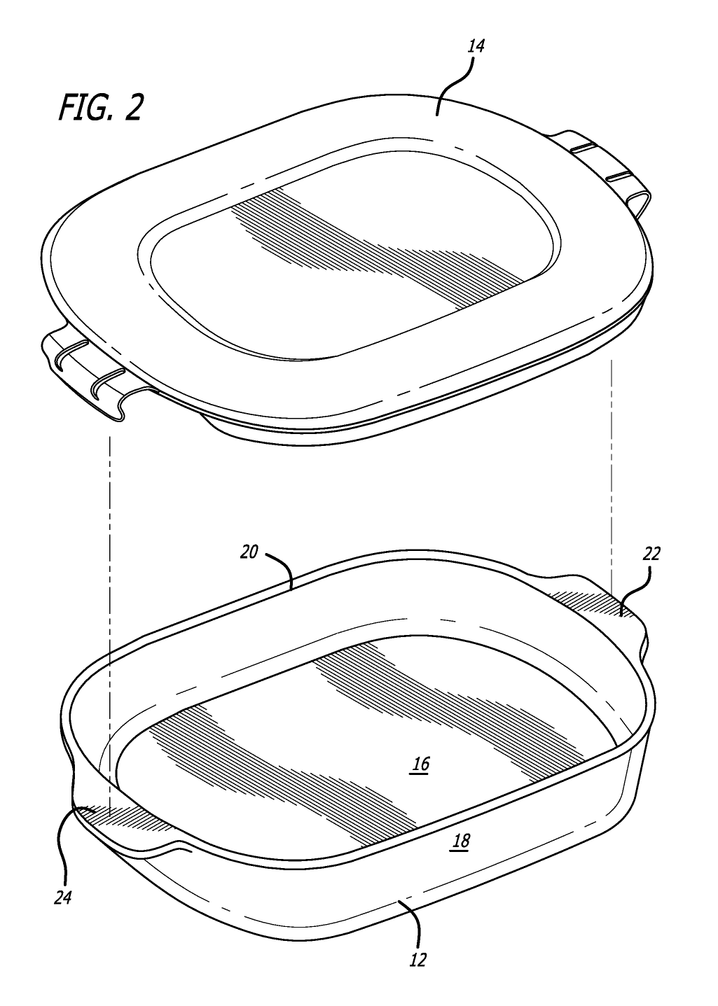

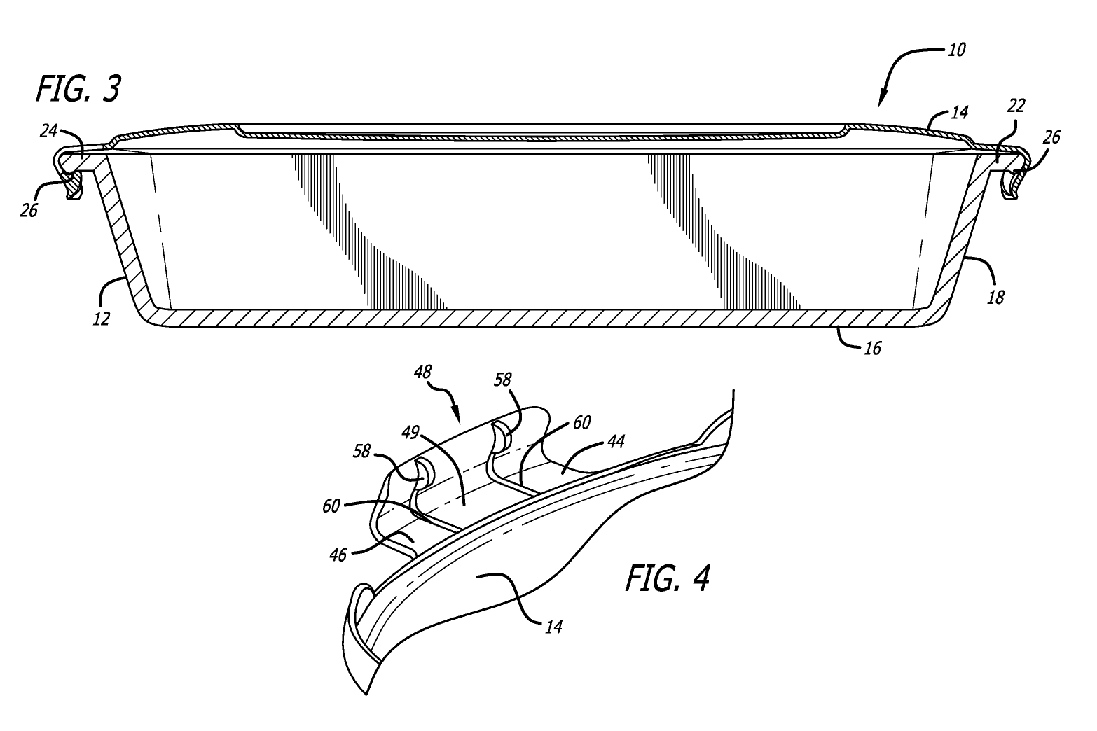

The vessel 12 generally includes a base 16 and a vessel sidewall 18. The sidewall 18 extends upwardly from the base 16 and terminates in an upper rim 20. As shown in FIGS. 2 and 3, the vessel 12 also includes a first tab handle 22 and a second tab handle 24. The first tab handle 22 extends outwardly from the upper rim 20. Similarly, the second tab handle 24 extends outwardly from the upper rim 20. The second tab handle 24 is disposed generally opposite the first tab handle 22. However, it is contemplated that the second tab handle 24 can be disposed at any position along the upper rim 20. It will also be understood that the tab handles 22, 24 may join to form a single rim that traverses portions of, or the entire, upper rim 20.

According to one embodiment shown in FIG. 3, the first and second tab handles 22, 24 each include a protrusion 26 projecting downwardly from a bottom surface 36 of the first and second tab handles 22, 24 proximate their respective outermost extent. As will be discussed in further detail below, each protrusion 26 will provide a complimentary catch for receiving a locking tab disposed on a complimentary surface of the storage lid 14 disclosed herein.

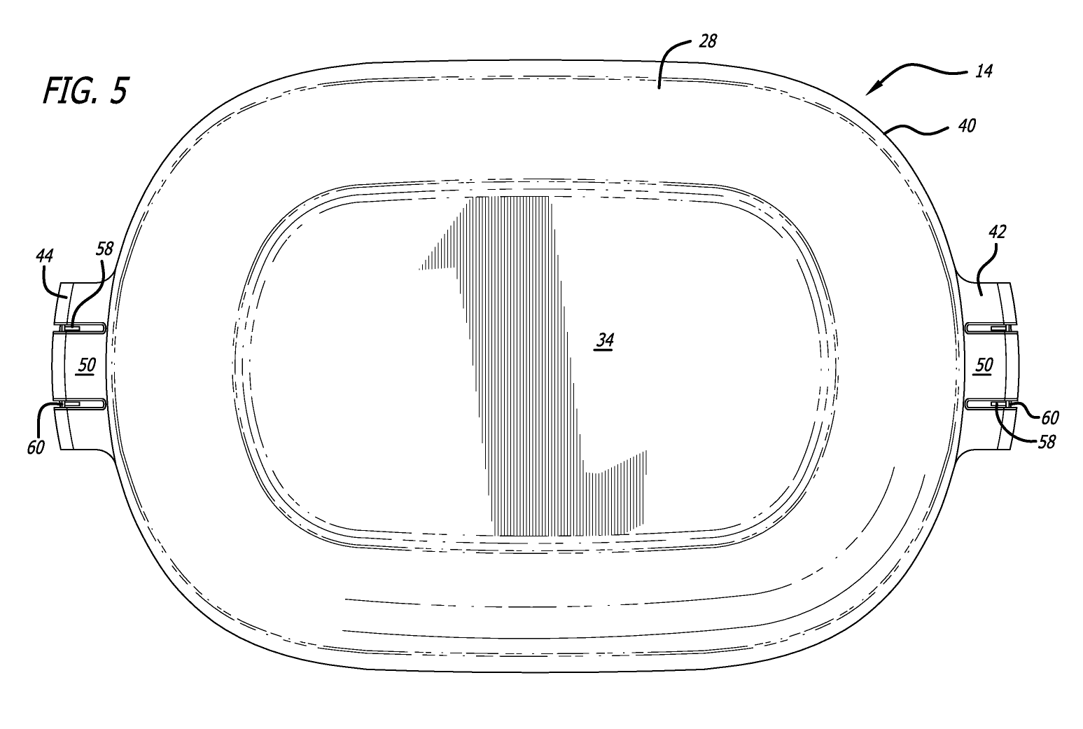

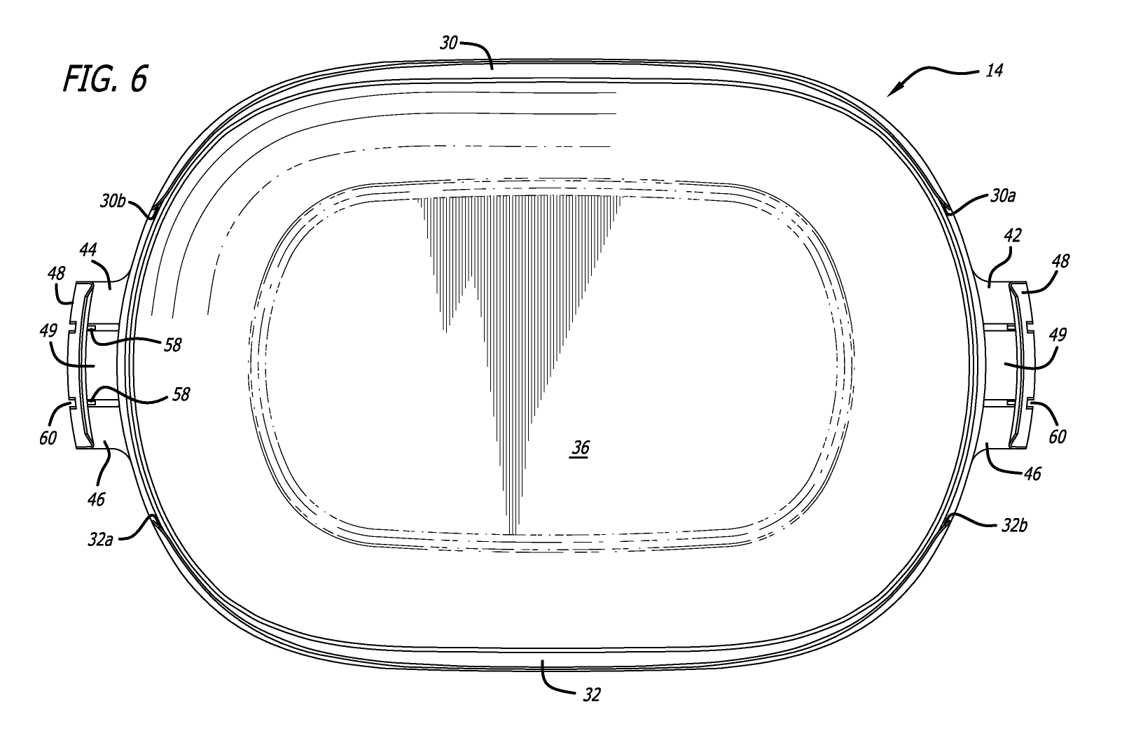

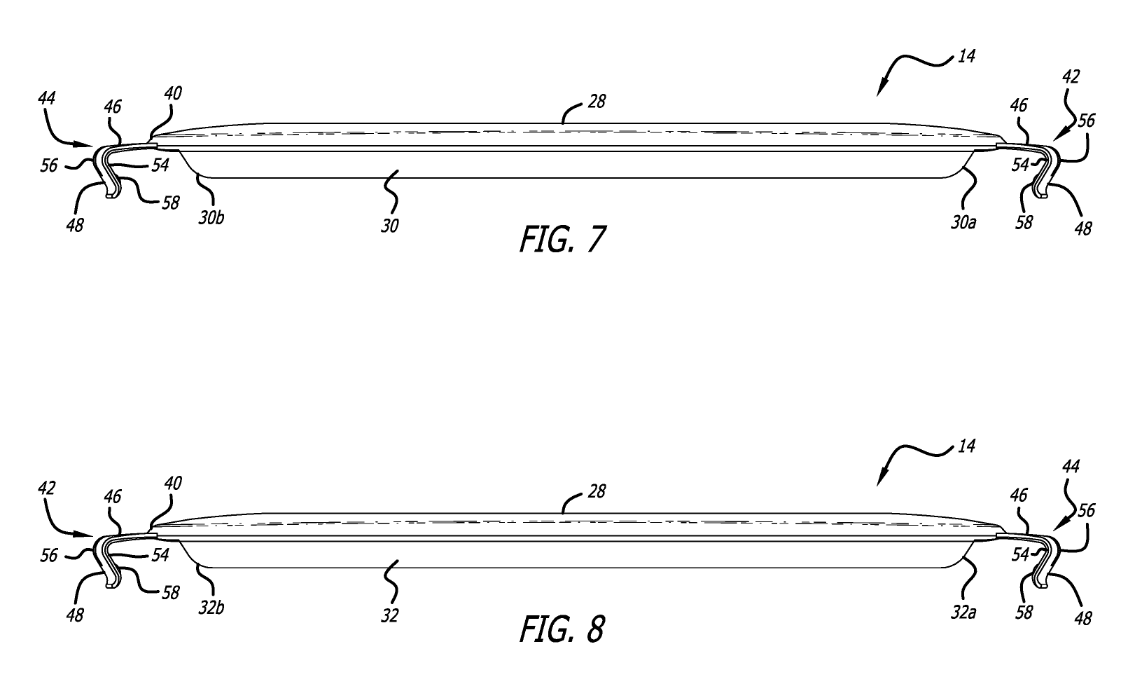

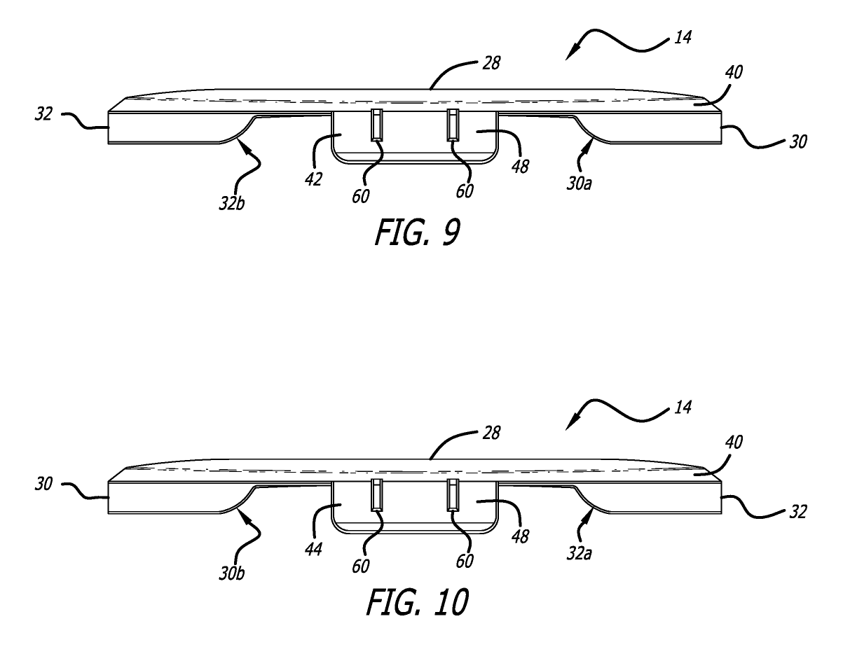

As shown in FIGS. 5-10, the storage lid 14 includes a cover portion 28, a first sidewall 30 and a second sidewall 32. The cover portion 28 has a generally outward facing top surface 34 and a bottom surface 36. The first sidewall 30 is connected to the cover portion 28 and extends downwardly and terminates at a terminal end 38. The first sidewall 30 has a first side an opposed second side. Similarly, the second sidewall 32 is connected to the cover portion 28 and extends downwardly and terminates in a terminal bottom end. The second sidewall 32 also has a first side an opposed second side. In one embodiment, the lid 14 has an intermediate rim 40 extending from the top surface 34 of the cover.

The intermediate rim 40 traverses a perimeter of the cover portion 28. According to this embodiment, the first and second sidewalls 30, 32 extend downwardly from the intermediate rim 40. In another embodiment, the first and second sidewalls 30, 32 extend directly from a perimeter of the cover portion 28.

The storage lid 14 also includes a flexible first locking tab 42 and a flexible second locking tab 44. The first locking tab 42 is connected to the cover portion 28 at a position between the first end 30a of the first sidewall 30 and the second end 32b of the second sidewall. The second locking tab 44 is connected to the cover at a position between the second end 30b of the first sidewall 30 and the first end 32a of the second sidewall 32. Again, it is contemplated that the first and second locking tabs 42, 44 be connected to the intermediate rim 40 or directly to the cover portion 28.

As shown in FIGS. 1-4, the first and second locking tabs 42, 44 each include a lateral portion 46 and a locking portion 48. The lateral portion 46 of each locking tab has an inner surface 49 and an outer surface 50. The lateral portion 46 extends outwardly in a direction that is generally parallel to the top surface 34 of the cover portion 28. The locking portion 48 also has an inner surface 54 and an outer surface 56. The locking portion 48 extends downward and inwardly at an angle from the lateral portion 46. Preferably, the angle (a) formed between the inner surface 48 of the lateral portion 46 and the inner surface 54 of the locking portion 48 is less than 90 degrees.

As shown in FIG. 4, the first and second locking tabs 42, 44 each include a locking protuberance 58 disposed on the inner surface of the locking portion 48. The locking tabs 42, 44 also include an elongate aperture 60 that extends along the lateral portion 46 and the locking portion 48 of the locking tab and terminating proximate the locking protuberance 58. In some embodiments, the locking tabs 42, 44 can include two or more elongate apertures 60. Accordingly, when the storage lid 14 is engaged to cover the vessel 12, the locking tabs 42, 44 cooperate with the corresponding tab handles 22, 24, or portions of the tab handles; for example, protrusions 26 on the tab handles 22, 24. The lid 14 is sized relative to the vessel 12 such that when the storage lid 14 engages the vessel 12, the flexible tabs are flexed upwardly and over the outer edge of the tab handles. The elongate aperture 60 facilitate flexibility of the flexible tabs. When the lid 14 is fully secured, the protuberance 58 on the respective locking portion 48 of the flexible locking member engages the lower surface of the respective tab handle thereby securing the lid 14 to the vessel 12.

Preferably, the storage lid 14 is formed from a polymer or an elastomer. However, it is contemplated that the cover may be formed from a material other than a polymer and only the first and second locking tabs 42, 44 are each formed from a polymer or elastomeric material.

The disclosed systems are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A storage lid for a vessel, the vessel including a base and a vessel sidewall extending upwardly from the base and terminating in an upper rim, a first tab handle extending outwardly from the upper rim; a second tab handle extending outwardly from the upper rim, the second tab handle being disposed opposite the first tab handle, the storage lid comprising:
a cover portion having a top surface;
a first sidewall connected to the cover portion extending downwardly and terminating at a terminal end, the first sidewall having a first side an opposed second side;
a second sidewall connected to the cover portion extending downwardly and terminating in a terminal bottom end, the second sidewall having a first side an opposed second side; and
a flexible first locking tab connected to the cover at a position between the first end of the first sidewall and the second end of the second sidewall and a flexible second locking tab connected to the cover at a position between the second end of the first sidewall and the first end of the second sidewall, the first and second locking tabs each comprising:
a lateral portion having an inner surface and an outer surface, the lateral portion extending outwardly in a direction that is generally parallel to the top surface of the cover portion, and
a locking portion extending downwardly and inwardly at an angle from the lateral portion, the locking portion having an inner surface and an outer surface;
a locking protuberance disposed on the inner surface of the locking portion; and
an elongate aperture disposed in a portion of the lateral portion, and the locking portion and terminating proximate the locking protuberance.

2. The storage lid of claim 1, further comprising an intermediate rim extending from a top surface of the cover and traversing a perimeter of the cover portion, wherein the first and second sidewalls extend downwardly from the intermediate rim.

3. The storage lid of claim 1, wherein the angle formed between the inner surface of the lateral portion and the inner surface of the locking portion is less than 90 degrees.

4. The storage lid of claim 1, wherein the first and second locking tabs are each formed from one of either an organic polymer and an elastomer.

5. A cookware assembly comprising:
a vessel comprising:
a base;
a vessel sidewall extending upwardly from the base and terminating in an upper rim;
a first tab handle extending outwardly from the upper rim;
a second tab handle extending outwardly from the upper rim, the second tab handle being disposed opposite the first tab handle; and,
a lid comprising:
a cover portion having a top surface;
a first sidewall connected to the cover portion extending downwardly and terminating at a terminal end, the first sidewall having a first side an opposed second side;
a second sidewall connected to the cover portion extending downwardly and terminating in a terminal bottom end, the second sidewall having a first side an opposed second side; and
a flexible first locking tab connected to the cover at a position between the first end of the first sidewall and the second end of the second sidewall and a flexible second locking tab connected to the cover at a position between the second end of the first sidewall and the first end of the second sidewall, the first and second locking tabs each comprising a lateral portion having an inner surface and an outer surface, the lateral portion extending outwardly in a direction that is generally parallel to the top surface of the cover portion, and a locking portion extending downwardly and inwardly at an angle from the lateral portion, the locking portion having an inner surface and an outer surface, wherein a locking protuberance is disposed on the inner surface of the locking portion, and an elongate aperture disposed in a portion of the lateral portion and the locking portion and terminating proximate the locking protuberance.

6. The cookware assembly of claim 5, wherein the cookware vessel is formed from ceramic material.

7. The cookware assembly of claim 5, further comprising an intermediate rim extending from a top surface of the cover and traversing a perimeter of the cover portion, wherein the first and second sidewalls extend downwardly from the intermediate rim.

8. The cookware assembly of claim 5, wherein the angle formed between the inner surface of the lateral portion and the inner surface of the locking portion is less than 90 degrees.

9. The cookware assembly of claim 5, wherein the first and second locking tabs are each formed from one of either an organic polymer and an elastomer.
